(19) United States
(12) Patent Application Publication
(10) Pub. No.: US 2006/0284049 A1
(43) Pub. Date: Dec. 21, 2006

(54) Coated foam form members for concrete structures

(75) Inventor: Mark England, Manchester, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Greenstreak, Inc.

(21) Appl. No.: 11/146,716

(22) Filed: Jun. 7, 2005

(51) Int. Cl. B28B 7/36

(52) U.S. Cl. 249/114.1

(57) ABSTRACT

A coated foam concrete form member, in one embodiment, includes a core formed from a foamed polymeric material, and a protective layer covering at least a portion of at least one outer surface of the core. The protective layer includes at least one film forming polymeric material.

### BACKGROUND OF THE INVENTION

This invention relates generally to building construction, and more particularly to coated and/or laminated foam form members for concrete structures.

Concrete pre-cast wall sections and cast-in-place wall sections are used in known building design. One of the popular systems available today is pre-cast concrete tilt-up wall panels. The wall section is first cast horizontally on a firm flat surface, for example, a temporary casting slab or the concrete floor of the building, by the use of a perimeter defining form. The concrete is poured into the area defined by the forms and is then permitted to harden or cure. In order that the concrete panel not adhere to the concrete floor, or surface supporting it, a commercially available chemical coating is first applied to the surface as a bond breaker. After the concrete has hardened to strength a heavy capacity lifting crane is employed to lift, or tilt, the wall section to a vertical position. The wall panel is set upon a concrete foundation or footing at which point it is temporarily supported until permanently incorporated into the building structure.

It is sometimes desirable, for artistic design and/or aesthetic reasons, that relief channels are cast into the flat concrete panel. Typically these relief channels extend horizontally across the concrete panel, but they can also extend vertically. One known method of forming the relief channels in the concrete panels is to fasten wooden strips cut to the desired shape of the relief channel onto the flat pouring surface between the perimeter forms before the concrete is poured. One problem that occurs with wooden strips is that any natural defects in the wood, for example, knots, are transferred to the hardened concrete. Another problem that occurs with wooden strips is the needed repair to the concrete floor that the wooden strips are nailed to. Further problems with wooden strips include moisture absorption which can cause swelling and warping of the strips, sap excretion which can cause discoloration of the concrete in contact with the wood, jagged edges and knots in the wood, and poor release properties of wood.

One attempt to overcome the short comings of wooden reveal strips is to make the reveal strips from plastic materials, for example, polyethylene and polypropylene. However, reveal strips made from these plastic materials are three to five times the cost of wooden strips, and there is a problem of availability of plastic reveal strips in the market place.

### BRIEF DESCRIPTION OF THE INVENTION

In one aspect, a form member for use in casting concrete articles is provided. The form member includes a foam core formed from a foamed polymeric material, and a protective layer covering at least a portion of at least one outer surface of the core. The protective layer includes at least one polymeric material.

In another aspect a form for casting concrete panels is provided. The form includes a plurality of outer perimeter form members connected together to define a casting area, and at least one foam form member. The foam form member includes a core formed from a foamed polymeric material, and a protective layer covering at least a portion of at least one outer surface of the core. The protective layer includes at least one polymeric material.

In another aspect, A method of making a form member is provided. The form member includes a foam core comprising a foamed polymeric material, and a protective layer covering at least a portion of at least one outer surface of the core. The protective layer includes at least one polymeric material. The method includes forming the foam core into a predetermined shape, and applying the protective layer to at least one outer surface of the foam core.

### BRIEF DESCRIPTION OF THE DRAWINGS

FIG. 1 is a schematic illustration of a concrete wall panel containing cast-in relief channels.

FIG. 2 is a schematic illustration of a form for constructing the concrete wall panel shown in FIG. 1.

FIG. 3 is a cross sectional schematic illustration of a reveal strip shown in FIG. 2 in accordance with an embodiment of the present invention.

FIG. 4 is a cross sectional schematic illustration of a chamfer strip shown in FIG. 2 in accordance with an embodiment of the present invention.

### DETAILED DESCRIPTION OF THE INVENTION

Forms for constructing concrete wall panels, that include coated foam members, are described in more detail below. The coated foam members are light weight, easily cut to size, and are adhesively attached to the flat concrete floor on which the concrete wall panel is cast. The use of an adhesive, for example, a pressure sensitive adhesive and/or two sided adhesive tape, eliminates the use of fasteners, such as, nails, screws, and wood dowels, to fasten the reveal strips to the concrete floor, and thus eliminates the need to repair fastener holes in the concrete floor when the casting of concrete wall panels is complete. The coated foam members are described below as being used as reveal strips in the concrete wall panel form; however, coated foam members can be formed into any shape and used as other parts of the concrete form, for example, chamfer strips and form-board support members with chamfer portions.

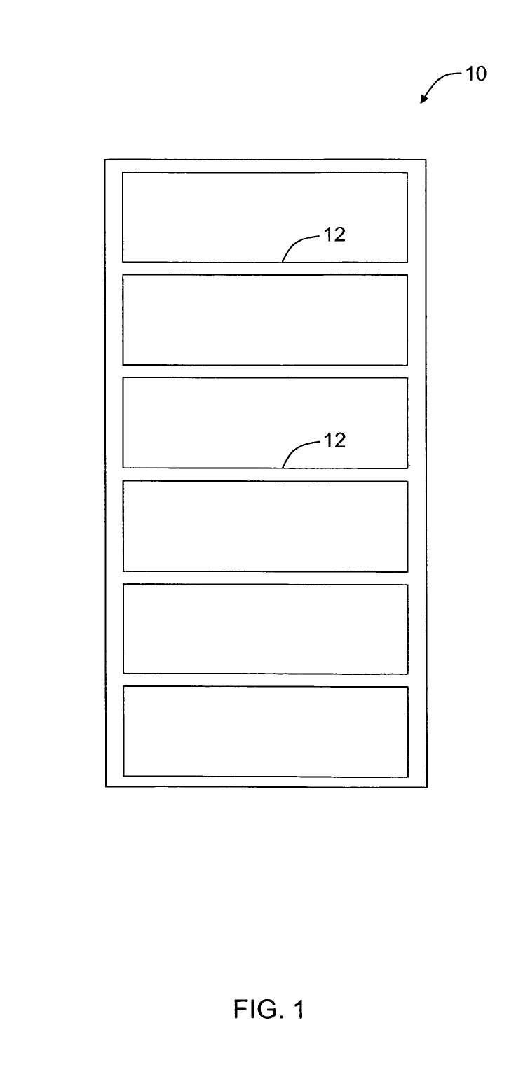

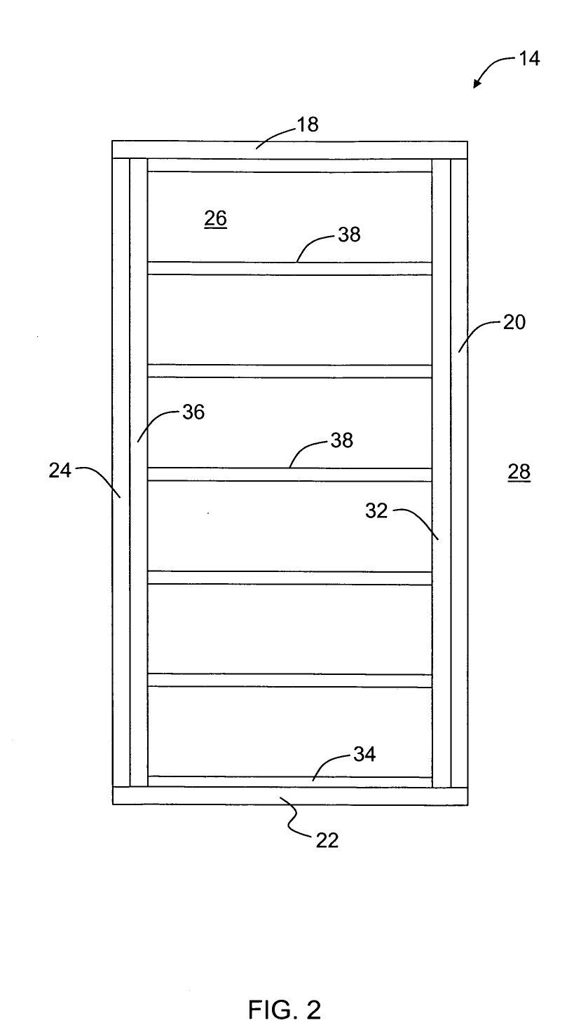

Referring to the drawings, FIG. 1 is a schematic illustration of a concrete wall panel 10 containing cast-in relief channels 12. FIG. 2 is a schematic illustration of a form 14 for constructing concrete wall panel 10. Referring FIGS. 1 and 2, form 14, in an exemplary embodiment, includes outer perimeter form members 18, 20, 22, and 24 arranged to form a rectangular casting area 26 for casting concrete wall panel 10. In other embodiments, form 14 is other than rectangular in shape, for example, square shape, trapezoid shape, parallelogram shape, and triangle shape. Outer perimeter form members 18, 20, 22, and 24 are secured to floor 28 by any suitable method, for example, fasteners and/or adhesives. Outer form members 18, 20, 22, and 24 can be formed from any suitable material, for example, wood, metal, and the like.

Chamfer strips, 30, 32, 34, and 36 are located in casting area 26 adjacent outer form members 18, 20, 22, and 24. Chamfer strips, 30, 32, 34, and 36 are used to form smooth beveled edges in concrete wall panel 10.

To form relief channels 12 in concrete wall panel 10, reveal/relief strips 38 are located in casting area 26 and extend between opposing outer form members 20 and 24. In the exemplary embodiment, reveal strips 38 are substantially parallel to outer form members 18 and 22 which define the top and bottom of concrete wall panel 10. In alternate embodiments, reveal strips are substantially parallel to outer form members 20 and 24, or at a predetermined angle to outer form members 18 and 22.

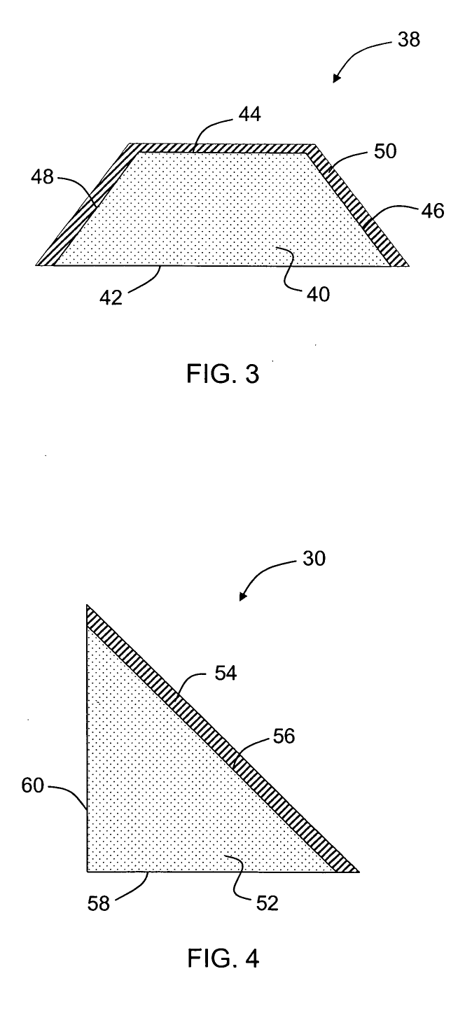

Reveal strips 38 and chamfer strips 30, 32, 34, and 36 are formed from a foamed polymeric material and include a protective layer on at least one surface of the foamed polymeric material. Particularly, and referring to FIG. 3, each reveal strip 38 includes a core 40 formed from a foamed polymeric material. Reveal strip core 40 has a substantially trapezoidal cross sectional shape and includes a bottom wall 42, a top wall 44 and opposing side walls 46 and 48 extending between bottom and top walls 42 and 44. In alternate embodiments, core 40 has other cross sectional shapes, for example, square, rectangular, circular, semi-circular, elliptical, and the like. Each reveal strip 38 also includes a protective layer 50 located on top wall 44 and side walls 46 and 48. In an alternate embodiment, protective layer 50 covers all the outer walls of core 40. Protective layer 50 is formed by depositing a film forming polymeric coating material onto walls 44, 46, and 48 of core 40. The thickness of protective layer 50, in one exemplary embodiment, is between about 0.5 mil to about 100 mils (about 12 micrometers to about 2500 micrometers). In another exemplary embodiment, the thickness of protective layer 50 is about 1.0 mil to about 50 mils (about 25 micrometers to about 1250 micrometers), and in still another exemplary embodiment, from about 5 mils to about 30 mils (about 125 micrometers to about 750 micrometers). In an alternate embodiment, protective layer 50 is formed from a polymeric film laminated to at least one wall of core 40. The thickness of the laminated polymeric film of protective layer 50 is about 1 mil to about 150 mils (about 25 micrometers to about 3750 micrometers).

Similar to reveal strips 38, and referring to FIG. 4, each chamfer strip 30, 32, 34, and 36 includes a core 52 formed from a foamed polymeric material and a protective layer 54 covering at least one outer wall of chamfer strip core 52. Similar to protective layer 50 described above, protective layer 54 is formed, in one embodiment, by a film forming polymeric coating material, and in another embodiment, from a polymeric film laminated to at least one outer wall of chamfer strip core 52. FIG. 4 illustrates chamfer strip 30; however, chamfer strips 32, 34, and 36 have an identical structure. In the exemplary embodiment, each chamfer strip 30, 32, 34, and 36 has a substantially triangular cross sectional shape and includes a first outer wall 56, a second outer wall 58, and a third outer wall 60.

Any suitable foamed polymeric material can be used to make reveal strip core 40 and chamfer strip core 52. Suitable foams include, but are not limited to, polystyrene foams, polyvinyl chloride foams, polyurethane foams, phenol-formaldehyde foams, urea formaldehyde foams, polyisocyanurate foams, polyolefin foams, and mixtures thereof. Reveal strip core 40 and chamfer strip core 52, in one embodiment, are formed by cutting a foam blank into the desired shapes. In another embodiment, reveal strip core 40 and chamfer strip core 52 are formed by extruding the foamed polymeric material into the desired shapes. The foamed polymeric material has a density, in one embodiment, of about 1 pound per cubic foot to about 4 pounds per cubic foot. In another embodiment, the density is about 2 pounds to about 3 pounds per cubic foot.

Any suitable film forming polymeric coating material can be used to form protective layers 50 and 54. Suitable film forming polymeric coating materials include, but are not limited to, polyurethane coatings, poly urea coatings, epoxy coatings, plastisol coatings, vinyl coatings, acrylic coatings, polyester coatings, and mixtures thereof. The coating can be applied by any suitable application method, for example, spray coating, dip coating, curtain coating, roll coating and the like. The coating can be applied by automatic or manual application equipment.

The coating is applied, in one embodiment, to a dry film thickness of about 12 micrometers to about 2500 micrometers, in another embodiment, to a dry film thickness of about 25 micrometers to about 1250 micrometers, and in another embodiment, to a dry film thickness of about 125 micrometers to about 750 micrometers. In the exemplary embodiment, the coating material is applied at 100 percent solids to minimize volatile emissions. In other embodiments, the coating material includes an appropriate solvent, for example, organic solvent or water, and is applied at a weight solids less than 100 percent, for example, from about 50 percent to about 99 percent.

Any suitable polymeric material film can be used as a laminate to form protective layers 50 and 54. Suitable polymeric material films include, but are not limited to polyurethane films, poly urea films, epoxy films, plastisol films, vinyl films, acrylic films, polyester films, polystyrene films, and mixtures thereof. The polymeric film can be applied by any suitable lamination method, for example, vacuum forming, adhesive bonding, pressure forming, thermal forming, thermal stamping, and compression forming.

In one exemplary embodiment the polymeric film is laminated to reveal strip core 40 and/or chamfer strip core 52 by heating a sheet of polymeric film to soften the film and then inserting the heated polymeric film into a backform template mold. Next, reveal strip core 40 and/or chamfer strip core 52 is inserted into the backform template mold to laminate the polymeric film to reveal strip core 40 and/or chamfer strip core 52. The polymeric film is then cooled and the laminated core 40 and/or 52 is removed from the mold. The excess polymeric film is then removed from core 40 and/or 52 by cutting and/or planning. In alternate embodiments, a plurality of reveal strip cores 40 and/or chamfer strip cores 52 can be laminated at one time by using a backform template mold that includes a plurality of core templates positioned side by side.

Concrete wall panel 10 is formed by assembling form 14 on floor 28. Outer form members 18, 20, 22, and 24 are secured to floor 28 and each other to define the shape and size of panel 10. Chamfer strips 30, 32, 34, and 36 are secured to floor 28 and outer form members 18, 20, 22, and 24 respectively by any suitable method, for example adhesive and/or adhesive tape. Reveal strips 38 are positioned in casting area 26 and are attached to floor 28 with, for example adhesive and/or adhesive tape. Concrete is poured into mold 14 and permitted to harden and cure. Outer form members 18, 20, 22, and 24 are removed and concrete panel 10 is lifted/tilted from floor 28 by, for example a crane. Any reveal strips 38 and chamfer strips that are embedded in the concrete are removed from panel 10 to form the finished concrete wall panel 10.

While the invention has been described in terms of various specific embodiments, those skilled in the art will recognize that the invention can be practiced with modification within the spirit and scope of the claims.

What is claimed is:

1. A form member for use in casting concrete articles, said form member comprising:
a foam core comprising a foamed polymeric material; and
a protective layer covering at least a portion of at least one outer surface of said core, said protective layer comprising at least one polymeric material.

2. A form member in accordance with claim 1 wherein said protective layer is formed from a coating comprising a film forming polymeric material.

3. A form member in accordance with claim 2 wherein a film thickness of said coating is about 12 micrometers to about 2500 micrometers.

4. A form member in accordance with claim 1 wherein said protective layer comprises a polymeric film laminated to said core.

5. A form member in accordance with claim 4 wherein a thickness of said laminated film comprises about 25 micrometers to about 3750 micrometers.

6. A form member in accordance with claim 4 wherein said polymeric film comprises at least one of polyurethane films, poly urea films, epoxy films, plastisol films, vinyl films, acrylic films, polyester films, and polystyrene films.

7. A form member in accordance with claim 1 wherein said core comprises a cross-sectional shape that is substantially trapezoidal, substantially square, substantially rectangular, substantially circular, substantially semi-circular, or substantially elliptical.

8. A form for casting concrete panels, said form comprising:
a plurality of perimeter form members connected together to define a casting area; and
at least one foam form member, said foam form member comprising:
a foam core comprising a foamed polymeric material; and
a protective layer covering at least a portion of at least one outer surface of said core, said protective layer comprising at least one polymeric material.

9. A form in accordance with claim 8 wherein said protective layer is formed from a coating comprising a film forming polymeric material.

10. A form in accordance with claim 9 wherein a film thickness of said coating is about 12 micrometers to about 2500 micrometers.

11. A form in accordance with claim 8 wherein said protective layer comprises a polymeric film laminated to said core.

12. A form in accordance with claim 11 wherein a thickness of said laminated film comprises about 25 micrometers to about 3750 micrometers.

13. A form in accordance with claim 11 wherein said polymeric film comprises at least one of polyurethane films, poly urea films, epoxy films, plastisol films, vinyl films, acrylic films, polyester films, and polystyrene films.

14. A form in accordance with claim 8 wherein said core comprises a cross-sectional shape that is substantially trapezoidal, substantially square, substantially rectangular, substantially circular, substantially semi-circular, or substantially elliptical.

15. A method of making a form member, the form member comprising a foam core comprising a foamed polymeric material, and a protective layer covering at least a portion of at least one outer surface of the core, the protective layer comprising at least one polymeric material, said method comprising:
forming the foam core into a predetermined shape; and
applying the protective layer to at least one outer surface of the foam core.

16. A method in accordance with claim 15 wherein forming the foam core into a predetermined shape comprises cutting at least one of a sheet of foam and a billet of foam into the predetermined shape.

17. A method in accordance with claim 15 wherein applying the protective layer comprises applying a coating of a film forming polymeric material to at least a portion of at least one outer surface of the foam core.

18. A method in accordance with claim 15 wherein applying the protective layer comprises laminating a polymeric film to the foam core.

19. A method in accordance with claim 18 wherein laminating a polymeric film to the foam core comprises laminating a polymeric film to the foam core by at least one of vacuum forming, adhesive bonding, pressure forming, thermal forming, thermal stamping, and compression forming.

20. A method in accordance with claim 18 wherein laminating a polymeric film to the foam core comprises:
providing at least one foam core of a predetermined shape;
providing a backform template mold for at least one foam core;
heating a sheet of polymeric film;
inserting the heated polymeric film into the backform template mold;
inserting the at least one foam core into the backform template mold to laminate the polymeric film to the at least one foam core;
cooling the polymeric film;
removing the at least one foam core laminated with the polymeric film; and
trimming excess polymeric film from each of the at least one foam core.
